(19) United States
(12) Patent Application Publication
(10) Pub. No.: US 2005/0161961 A1
(43) Pub. Date: Jul. 28, 2005

(54) Hand-held pick-and-place apparatus with adhesive grasping element, components thereof, and associated methods

(76) Inventors: Eric J. Ruff, Orem, UT (US); Enoch M. Golding, Orem, UT (US)

Correspondence Address: TRASK BRITT, P.O. BOX 2550, SALT LAKE CITY, UT, 84110, US

(21) Appl. No.: 10/763,485

(22) Filed: Jan. 23, 2004

(51) Int. Cl. B25J 1/00

(52) U.S. Cl. 294/1.1

(57) ABSTRACT

A hand-held pick-and-place apparatus includes a body, a tip secured to the body, and a grasping element which may be contained within one or both of the body and the tip and which may be extruded through the tip. An exposed exterior end of the grasping element is useful for picking up pieces for modification, manipulation, or transport thereof. The pick-and-place apparatus may also include a cap disposable over the tip so as to protect the exposed exterior end of the grasping element as the apparatus is being stored. An accessory tool which includes one or more tools, such as a placement tip, a rounded stylus, tweezers, a cutting blade, a ball point, a poker, an adhesive applicator, a brush, a scraper, or writing or marking instrument, may be securable to the pick-and-place apparatus. The accessory tool may be used while it is secured to the pick-and-place apparatus, or removed therefrom prior to use.

### BACKGROUND OF THE INVENTION

1. Field of the Invention

The present invention relates to apparatus for grasping, holding, and positioning small articles, such as small pieces of papers. More specifically, the present invention relates to apparatus with adhesive elements formed from tacky material that are configured to temporarily grasp small articles without damaging the small articles or leaving a residue thereon. In addition, the present invention relates to methods for manufacturing and using such apparatus.

2. Background of Related Art

Conventionally, an individual's fingers or devices such as tweezers have been used to grasp, hold, and position articles, such as small pieces of paper. The use of tweezers is usually necessitated due to the small size of the articles that are to be held, or positioned. It is well-known that when tweezers are used, the two tips thereof are placed on generally opposite sides of the article to be grasped. The tips are then forced together, biasing the same against the generally opposite sides of the article and, thereby, grasping the article. While the tweezers are grasping the article, they may hold the article in place while another task is performed (e.g., application of glue thereto) or they may be used to position the article.

Tweezers have found widespread use by scrapbookers, by individuals performing arts and crafts, and in offices, schools and other settings, particularly for grasping the small pieces of paper or other materials that are often used on scrapbooking pages. Once such an article has been grasped, the scrapbooker may apply an adhesive (i.e., glue) to the article. The tweezers may then be used to position the article at the desired location, to which the article is secured by way of the adhesive.

Due to their minute size, small articles are often delicate. Nonetheless, when tweezers are used, potentially damaging forces are applied to articles that are grasped thereby. For example, when tweezers with relatively small tips are closed too tightly, they may crush or cut into the article that is to be grasped thereby.

Moreover, when the article to be held or positioned is very thin, such as a small piece of paper or of another material, it may be difficult to position one of the tips of tweezers beneath the article or to otherwise grasp the article. As a result, one may attempt to grasp the article by positioning the tips at opposite edges of the article. Consequently, the article may be bent as force is applied to the tips so as to grasp the article.

When tweezers are used to hold a small piece of paper or other material as adhesive or another material is applied thereto, one of the tips of the tweezers may cover a portion of the surface of the article, preventing application of the adhesive or other thereto. As a result, a portion of the article may not be adhered to a scrapbook page or other sheet of material (e.g., poster board, paper, etc.), which may facilitate the undesirable peeling of the article from the scrapbook page or other sheet of material, or the surface to which another material is applied may not be fully covered by that material.

Accordingly, there is a need for an apparatus that may be used to pick up, hold, and position small articles without damaging the same and while providing unobstructed access to at least one surface thereof.

### SUMMARY OF THE INVENTION

The present invention includes a hand-held pick-and-place apparatus that is configured to grasp, hold, or position small articles, such as pieces of paper or other materials. Components of the hand-held pick-and-place apparatus are also within the scope of the present invention, as are methods of using the apparatus and its components.

An exemplary embodiment of hand-held pick-and-place apparatus according to the present invention includes a hand-held body and a grasping element, or adhesive element, exposable at an end thereof. The grasping element, which is configured to be placed in contact with a small article to be grasped and held or positioned, comprises a tacky material from which the grasped article may be subsequently removed while leaving substantially no residue on the article.

Additionally, the hand-held pick-and-place apparatus may include a storage cavity within which the material of the grasping element is stored, as well as a delivery element, such as a longitudinally movable tip or a longitudinally moveable interior element, for delivering a desired quantity of the material of the grasping element to the exterior of the housing. The hand-held pick-and-place apparatus may also include a removable and replaceable cap for protecting the grasping element when the hand-held pick-and-place apparatus is not in use.

The hand-held pick-and-place apparatus may include one or more attachment elements on or associated with the housing so as to facilitate the securing of one or more accessories thereto. An example of such an accessory includes a rounded stylus at one end and a placement tip at the opposite end. The rounded stylus may be configured with a large, smooth surface to facilitate the application of pressure to pieces or articles that have been positioned upon a substrate without damaging the pieces or articles. The placement tip may be configured to facilitate removal of an article from the grasping element following positioning thereof at a desired location. Of course, hand-held pick-and-place apparatus that include other accessories, such as styli, tweezers, scrapers, cutting blades, ball-points, pokers, applicators for adhesives or other materials, brushes, writing or marking instruments, and the like, are also within the scope of the present invention.

In use, a desired amount of the tacky material of the grasping element may be provided at the end of the housing of a hand-held pick-and-place apparatus that incorporates teachings of the present invention, then molded (e.g., by hand) into a desired shape (e.g., a point for grasping very small articles, a flat end surface for grasping somewhat larger articles, an enlarged end for grasping relative large articles, etc.). The grasping element is then brought into contact with an article to be grasped. In addition, the grasping element may be forced against the article to ensure that the article will be grasped. Once the article has been adhered to the grasping element, the article may be held in place while adhesive or another substance is applied thereto, while it is being altered (e.g., cut, folded, etc.), or while any other task is being performed thereon or therewith. Alternatively, following adhesion of the article to the grasping element, the article may be transferred to another, possibly more secure grasping device (e.g., styli, tweezers, scrapers, cutting blades, ball-points, pokers, applicators for adhesives or other materials, brushes, writing or marking instruments, etc.), then another task (e.g., application of adhesive or another substance, alteration of the article, etc.) may be performed on or with the article. The article may then be positioned at a desired location on a page of a scrapbook or on another substrate, such as a sheet of paper, a poster board, or the like. In order to effect removal of the article from the grasping element, a placement tip, tweezers, or another apparatus may be placed nonadhesively against the article as the hand-held pick-and-place apparatus is removed therefrom.

Other features and advantages of the present invention will become apparent to those of skill in the art through a consideration of the ensuing description, the accompanying drawings, and the appended claims.

### BRIEF DESCRIPTION OF THE DRAWINGS

In the drawings, which depict exemplary embodiments of various features of the present invention:

FIG. 1 is a cross-sectional assembly view of an exemplary embodiment of hand-held pick-and-place apparatus according to the present invention;

FIG. 2 is a cross-sectional representation of the elements of the hand-held pick-and-place apparatus of FIG. 1 in an assembled relationship, taken along line 2-2 of FIG. 1;

FIG. 2A is a cross-sectional representation of another embodiment of hand-held pick-and-place apparatus that incorporates teachings of the present invention;

FIGS. 3A-3C are cross-sectional representations illustrating various positions of a tip of the hand-held pick-and-place apparatus of FIGS. 1 and 2 relative to a body thereof;

FIGS. 4A-4C depict various shapes of an exterior end of a grasping element protruding from the tip of the hand-held pick-and-place apparatus;

FIGS. 5A and 5B illustrate use of the hand-held pick-and-place apparatus;

FIG. 6 is a cross-sectional representation of an exemplary embodiment of a cap that may be used to cover the tip of the hand-held pick-and-place apparatus shown in FIGS. 1 and 2;

FIG. 7 is a side view of an example of an accessory tool that may be used with and secured to the hand-held pick-and-place apparatus illustrated in FIGS. 1 and 2;

FIG. 7A is a side assembly view of another example of an accessory tool that may be used with and secured to the hand-held pick-and-place apparatus illustrated in FIGS. 1 and 2;

FIG. 8 is a side view of another embodiment of accessory tool that may be used with and secured to the hand-held pick-and-place apparatus of FIGS. 1 and 2;

FIGS. 9A and 9B depict use of a pointed end of the accessory tool in conjunction with the exterior end of the grasping element protruding from the tip of the hand-held pick-and-place apparatus; and

FIG. 10 illustrates use of a rounded end of the accessory tool to facilitate securing a piece of a material to a larger substrate, such as a sheet of paper or other material, a poster board, or the like.

### DETAILED DESCRIPTION

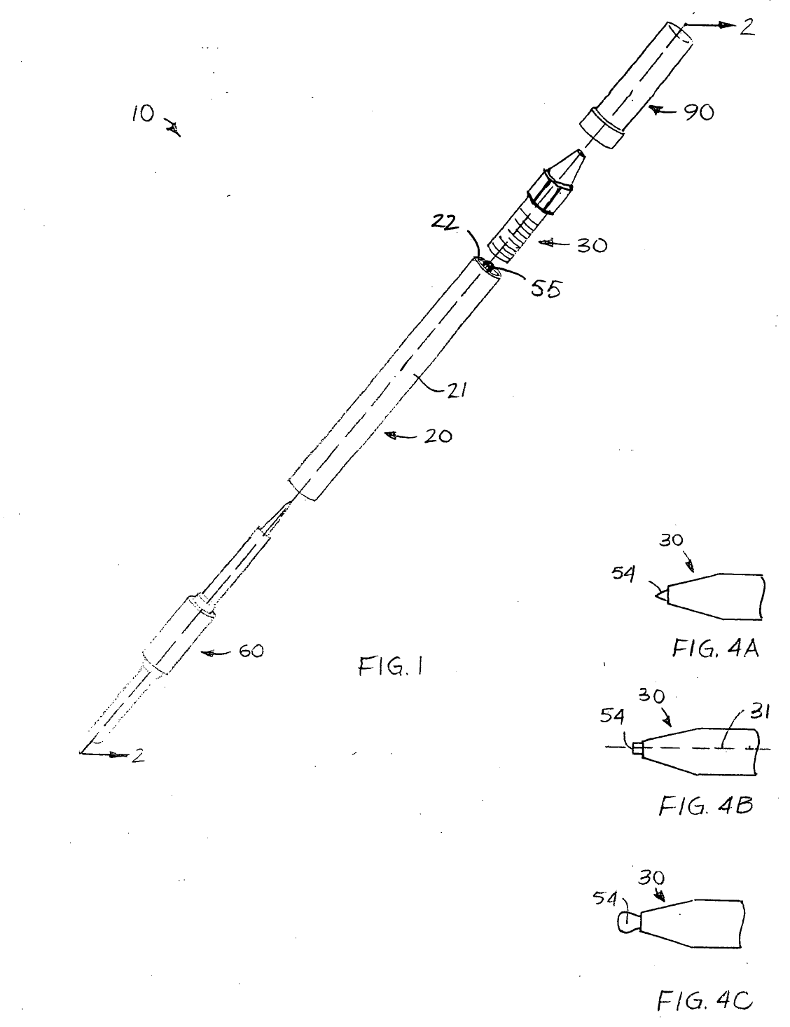

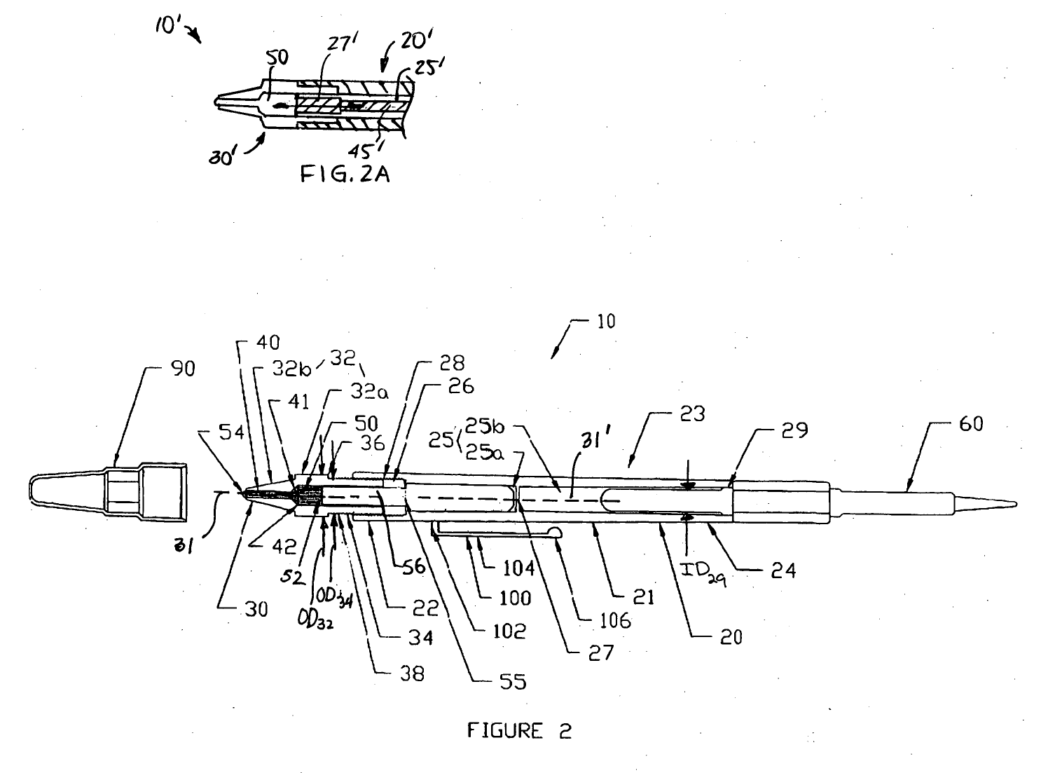

With reference to FIGS. 1 and 2, an exemplary embodiment of hand-held pick-and-place apparatus 10 according to the present invention is depicted. For simplicity, hand-held pick-and-place apparatus 10 is also referred to herein as a “pick-and-place apparatus 10.” Pick-and-place apparatus 10 includes a hand-held body 20 and an adhesive tip, which is also referred to herein as a “tip 30” for simplicity, configured to be received and retained by one end 22 of body 20. A grasping element 50 (FIG. 2), which is formed from a tacky material, is at least partially retained by tip 30. Pick-and-place apparatus 10 may also include a cap 90, which may be disposable over tip 30 and configured to engage tip 30. In addition, pick-and-place apparatus 10 may include an accessory tool 60, which is configured to be retained by and protrude from another end 24 of body 20.

By way of example only, all of the elements of pick-and-place apparatus 10, other than grasping element 50, may be formed from injection-moldable plastic. Of course, other types of plastic (e.g., thermoset plastics, two-part epoxies, etc.) may also be used to form the elements of a pick-and-place apparatus according to the present invention, as may other materials, including, without limitation, metals, carbon fibers, wood, and any other suitable materials.

As shown, body 20 is an elongate member which is at least partially hollow. The depicted example of body 20 is a substantially cylindrical-shaped tube which includes a storage cavity 25 that extends along the entire length thereof. Other exemplary shapes for body 20 include, but are not limited to, elongate prismatic shapes having substantially consistent cross-sectional shapes (e.g., triangular, rectangular, hexagonal, etc.) and dimensions taken along the lengths thereof, ergonomic shapes, or any other suitable shape. The majority of the exemplary storage cavity 25, which extends through a central region 23 of body 20, may have a substantially constant internal cross-sectional dimension, taken along the length thereof. Of course, storage cavities 25 with nonconstant internal cross-sectional dimensions, such as tapered storage cavities, stepped storage cavities, and the like, are also within the scope of the present invention.

The portion of storage cavity 25 which is located at an end 22 of body 20 is referred to herein as a “tip-engagement receptacle 26” or as a “tip-engagement element.” Tip-engagement receptacle 26 may, by way of example only, include threading 28 or other means for engaging tip 30 (e.g., a pair of spring-biased tabs or protrusions on one of a body-engagement end 34, or body-engagement element, of tip 30 or tip-engagement receptacle 26 of body 20 that are configured to be received by corresponding series of linearly arranged recesses formed in the other of body-engagement end 34 and tip-engagement receptacle 26, or otherwise, as known in the art) on or within a surface thereof.

At end 24 of body 20, storage cavity 25 may form an accessory attachment element 29, which is configured to receive and retain a complementarily configured portion of accessory tool 60.

As shown in FIG. 2, an interior fixed element 27, in this case an interior wall which extends across the central portion of storage cavity 25, may separate storage cavity 25 into two sections 25a and 25b. Section 25a communicates with tip-engagement receptacle 26 and is configured to receive a plunger 55, which includes a tip 56 configured to be positioned coaxially within storage cavity and, thus, is spaced apart from interior surfaces of section 25a of storage cavity 25. Section 25b communicates with accessory attachment element 29.

With continued reference to FIGS. 1 and 2, tip 30, which is configured to be secured at end 22 of body 20, includes a body-engagement end 34 and an exposed end 32. A circumferentially extending ledge 36 may delineate body-engagement end 34 from exposed end 32. In the illustrated example, body-engagement end 34 of tip 30 is substantially cylindrical in shape, while exposed end 32 includes an elongate section 32a which extends from body-engagement end 34 to a substantially conical section 32b. As a dimension extending transversely through and substantially perpendicular to a central axis of elongate section 32a of exposed end 32, which dimension is referred to herein as “outer diameter OD₃₂,” is larger than the corresponding dimension, referred to herein as “outer diameter OD₃₄,” of body-engagement end 34, ledge 36 faces in the same direction as that in which body-engagement end 34 extends. Of course, tip 30 and body 20 of pick-and-place apparatus 10 may have other complementary configurations that facilitate assembly thereof. In such configurations, rather than being larger than OD₃₄, OD₃₂ may be smaller than OD₃₄.

Body-engagement end 34, which is configured to be longitudinally inserted into tip-engagement receptacle 26, includes threading 38 or other means for engaging body 20 on or in an outer surface thereof. Threading 38 is configured complementarily to threading 28 within tip-engagement receptacle 26 to facilitate mutual engagement between tip-engagement receptacle 26 of body 20 and body-engagement end 34 of tip 30. If, as an alternative, other means for engaging are used to facilitate mutual engagement between tip-engagement receptacle 26 of body 20 and body-engagement end 34 of tip 30, such other means also complement one another. In any event, threading 38 or other means for engaging of tip 30 and complementary threading 28 of other means for engaging of tip-engagement receptacle 26 are configured to facilitate positioning of tip 30 at a plurality of longitudinal positions relative to body 20. Tip 30 is, accordingly, also referred to herein as a “delivery element.”

Tip 30 also includes a retention channel 42 for grasping element 50, as well as a delivery channel 40, both of which extend substantially along a central longitudinal axis 31 of tip 30. Retention channel 42, which may, as depicted, have substantially uniform cross-section taken along central longitudinal axis 31, opens to an exterior of tip 30 and extends substantially through cylindrical section 32a of exposed end 32 of tip 30. When body-engagement end 34 of tip 30 is positioned within tip-engagement receptacle 26 of body 20, plunger 55 is positioned substantially in-line with retention channel 42. Delivery channel 40, which communicates and is in alignment with retention channel 42, extends through exposed end 32 of tip 30, opening to an exterior thereof. Thus, delivery channel 40 delivers tacky material of grasping element 50 to an exterior of tip 30. The junction between retention channel 42 and delivery channel 40 may comprise a tapered region 41 to facilitate the movement of grasping element 50 from retention channel to delivery channel 40.

It is currently preferred that the tacky material of grasping element 50 comprise a material which, when in contact with an article for periods of time (e.g., minutes or seconds) that are needed to grasp or move the article, leaves substantially no residue on the article, such as a piece 110 (FIGS. 5A, 5B, 9A, 9B, and 10). The tacky material of grasping element 50 may be substantially acid-free or lignin-free, or otherwise “archival-safe.” By way of example only, the material marketed by Elmer's Products Inc. as TACK REMOVABLE ADHESIVE PUTTY may be used as the tacky material of grasping element 50.

As an example of the manner in which body 20 and tip 30 may engage one another, body 20 and tip 30 are substantially longitudinally aligned with one another, with body-engagement end 34 of tip 30 in proximity to and facing tip-engagement receptacle 26 of body 20. Body-engagement end 34, as well as grasping element 50 is then inserted into tip-engagement receptacle 26. The means for engaging of both body-engagement end 34 and tip-engagement receptacle 26 are then caused to mutually engage one another. For example, the means for engaging may comprise threadings 28, 38, as illustrated. In such an embodiment, tip 30 and body-engagement end 34 thereof may be rotated (e.g., in a clockwise direction) relative to body 20 to cause threading 38 of body-engagement end 34 to engage threading 28 of tip-engagement receptacle 26.

Such rotation may be effected until an interior end 52 of grasping element 50 abuts plunger 55 and a desired amount of tacky material of grasping element 50 has been extruded from tip 30 to form an exposed exterior end 54 of grasping element 50, as shown in FIG. 2. Alternatively, if the material of grasping element 50 has a low viscosity and is compressible, there may be some latency, or time delay, between an act, such as rotation of tip 30, that is intended to extrude a portion of grasping element 50 and relaxation of the material of grasping element 50 substantially to a state of equilibrium, during which the desired extrusion actually occurs. Accordingly, the extrusion-causing action may be effected in small increments to avoid extrusion of a larger than desired portion of grasping element 50, the extrusion-causing action may be metered to eventually result in extrusion of substantially a predetermined amount of grasping element 50, or an excess portion of grasping element 50 that is extruded may be removed from the remainder of grasping element 50 and discarded.

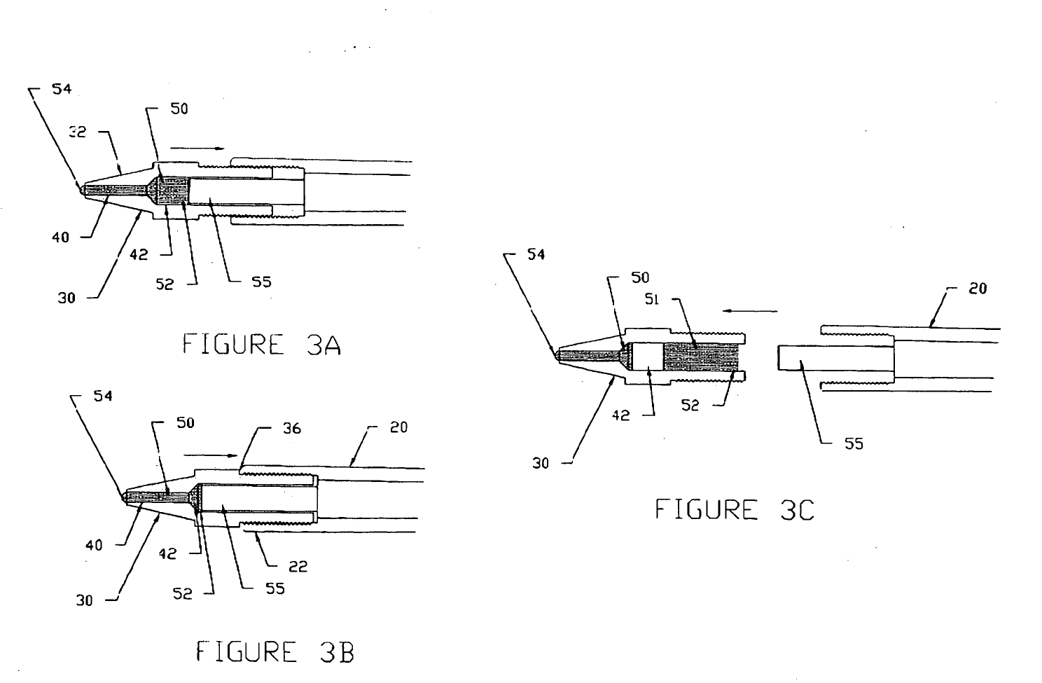

When it is desired that an additional grasping element 50 at an exterior end 54 thereof be extruded from tip 30, such as when an exposed portion of grasping element 50 becomes covered with lint, dust, or the like, or otherwise loses some of its tackiness (e.g., due to aging, exposure, etc.), or when an external end 54 of grasping element 50 breaks from the remainder thereof, tip 30 may be further rotated in the engaging direction (e.g., clockwise) to the position shown in FIG. 3A. When such rotation occurs, plunger 55 (FIG. 2) holds interior end 52 of grasping element 50 in place, causing a portion of the length of grasping element 50 to be forced longitudinally through retention channel 42 and delivery channel 40 as they advance longitudinally toward plunger 55. As a result, additional tacky material of grasping element 50, at exterior end 54, is forced out of exposed end 32 of tip 30.

FIG. 3B shows the tip 30 in a fully inserted position relative to body 20 of pick-and-place apparatus 10, with ledge 36 of tip 30 abutting end 22 of body 20. When tip 30 is in this position, and once grasping element 50 no longer includes an exterior end 54 or exterior end 54 is no longer useful, replacement of grasping element 50 or tip 30 (e.g., with a replacement tip of the same or similar configuration) is necessary.

Of course, other configurations of pick-and-place apparatus 10, as well as of body 20 and tip 30 thereof, that facilitate the storage and controlled or metered delivery of tacky material of grasping element 50 to the exterior of tip 30 by other mechanisms are also within the scope of the present invention. For example, and with reference to FIG. 2A, a pick-and-place apparatus 10 that incorporates teachings of the present invention may include a tip 30 that, when secured to body 20, remains in a substantially stationary position, while a delivery element, such as an interior element 27 or other longitudinally moveable element of body 20, is configured to move longitudinally along storage cavity 25 and is associated with an actuator 45 (e.g., a rotational actuator, a linearly-traveling actuator, etc.) to cause such movement, thereby effecting the receipt of at least a portion of grasping element 50 to an exterior of tip 30.

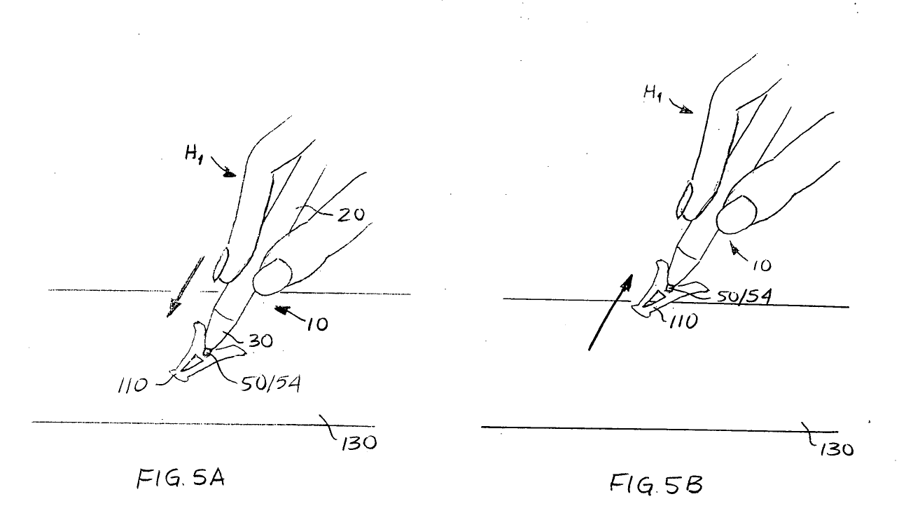

Turning now to FIGS. 4A-4C, if desired, the newly exposed exterior end 54 of grasping element 50 may be shaped. By way of example only, the newly exposed exterior end 54 of grasping element 50 may be shaped to a point, as shown in FIG. 4A, having diameter at an end thereof which is useful for picking up pieces of material (e.g., paper, cloth, plastic film, foil, etc.) of particular size. Such shaping may be effected manually or otherwise, such as by placing pick-and-place apparatus 10 (FIGS. 1 and 2) at an angle to a surface with exterior end 54 of grasping element 50 (FIGS. 1 and 2) in contact with the surface and rotating pick-and-place apparatus 10 until exterior end 54 assumes a substantially conical or frustoconical shape. As another example, depicted in FIG. 4B, exterior end 54 may be shaped with a substantially flat surface, which may be oriented perpendicular to central longitudinal axis 31 of tip 30, as shown, or at an angle thereto. Such shaping may be effected by placing exterior end 54 on a substantially planar surface at a desired angle, then by applying pressure to pick-and-place apparatus 10. FIG. 4C, which shows an enlarged exterior end 54 on grasping element 50, provides yet another example of the manner in which exterior end 54 may be shaped. Of course, it may also be desirable or necessary to reshape exterior end 54 of grasping element 50 following use or storage of pick-and-place apparatus 10.

Turning now to FIGS. 5A and 5B, an example of the manner in which pick-and-place apparatus 10 may be used is illustrated. As shown in FIG. 5A, once a desired amount of tacky material of grasping element 50 has been extruded from tip 30 and, optionally, formed into a desired shape, pick-and-place apparatus 10, the body 20 of which an individual holds with her hand H₁, is brought into proximity to an article, or piece 110, (e.g., a piece of a sheet of paper, card stock, fabric, plastic film, foil, etc.) that rests upon a surface 130 and which is to be held and transported, manipulated, or modified while secured to grasping element 50 of pick-and-place apparatus 10. As an exterior end 54 of grasping element 50 is brought into contact with piece 110, the individual, with her hand H₁, forces pick-and-place apparatus 10 toward piece 110 in such a way as to press exterior end 54 of grasping element 50 against piece 110 and, thus, to cause piece 110 to adhere to exterior end 54.

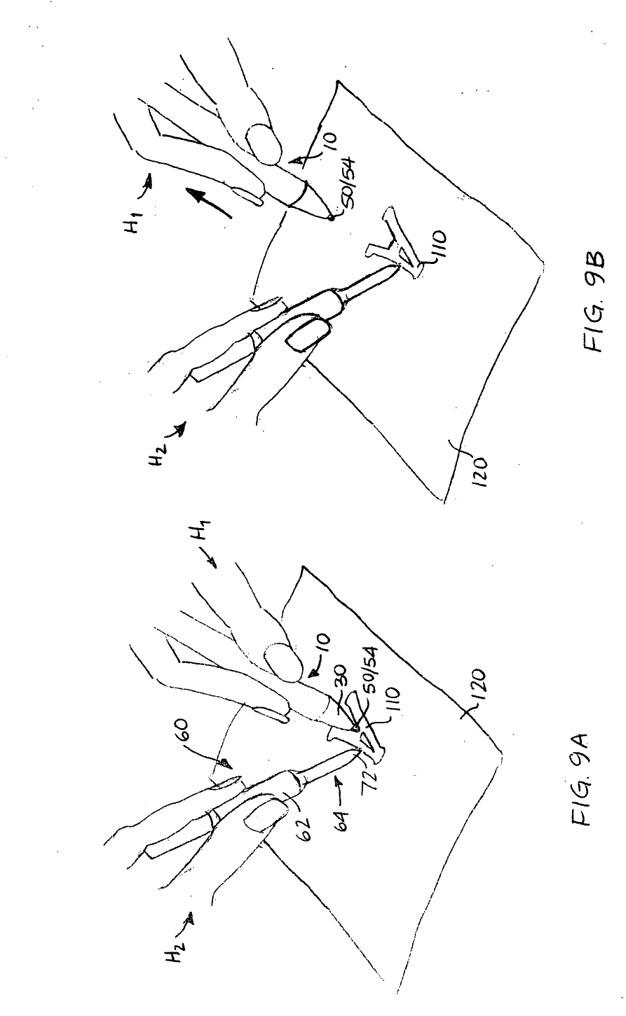

Next, as shown in FIG. 5B, the individual, again with her hand H₁, may pull pick-and-place apparatus 10 away from surface 130, with piece 110 remaining adhered to exterior end 54 of grasping element 50. While piece 110 is adhered to exterior end 54, piece 110 may be manipulated (e.g., bent, folded, cut, etc.), one or more substances (e.g., an adhesive, ink, paint, glitter, or other substances) may be applied thereto, or piece 110 may be transported to a desired location, such as to a particular position upon a substrate 120, as shown in FIG. 9A.

With reference to FIG. 3C, once all of the tacky material of grasping element 50 has been used, or replacement thereof is otherwise desired (e.g., due to loss of tackiness from aging or exposure, because of undesirable characteristics of a particular type of tacky material for a type of material to be picked up therewith, etc.), tip 30 may be removed from body 20 of pick-and-place apparatus 10 by disengaging complementary means for engaging of tip 30 and body 20, such as by rotation (e.g., counterclockwise rotation, clockwise rotation, etc.) of tip 30 relative to body 20.

Next, a new portion 51 of grasping element 50 may be introduced into retention channel 42. Plunger 55 may be disposed against interior end 52 of grasping element 50. Tip 30 may then be replaced on body 20, such as in the manner that has been described herein.

As an alternative to replacing tacky material of grasping element 50 in tip 30, a new tip 30, which has been pre-loaded with a replacement grasping element 50, may be secured to body, such as in the manner that has been described herein.

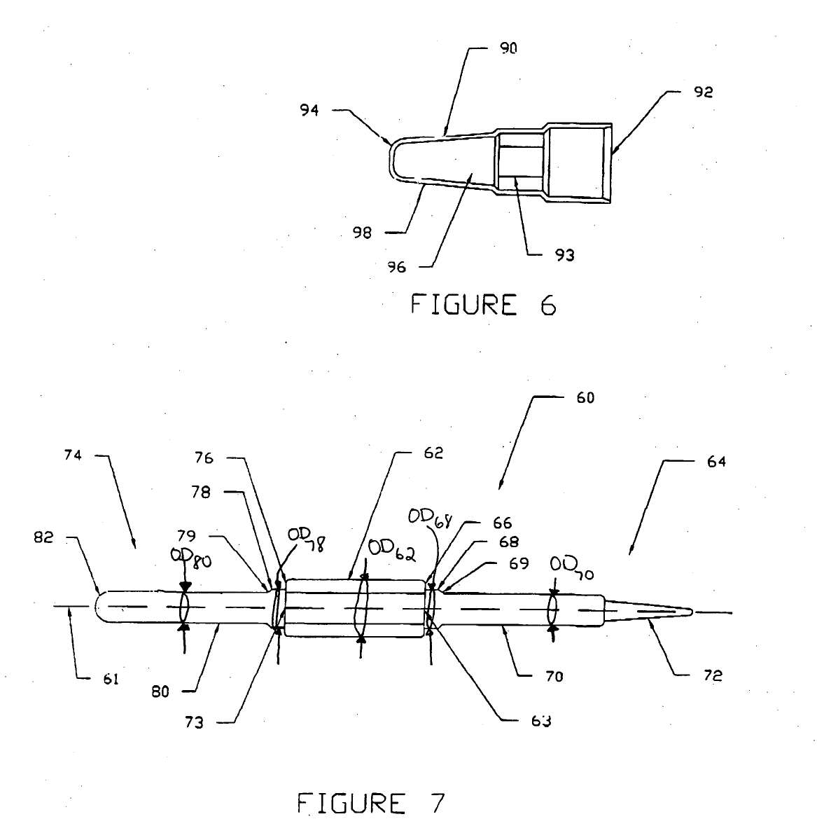

Referring now to FIG. 6, as well as to FIGS. 1 and 2, as noted previously herein, pick-and-place apparatus 10 may also include a cap 90. Cap 90 is configured to be placed on tip 30. As such, cap 90 protects exterior end 54 of grasping element 50 when pick-and-place apparatus 10 is not in use.

To this end, cap 90 is a substantially hollow, close-ended member which includes an outer wall 98 within which a tip receptacle 96 is formed. One end of cap 90, which is referred to herein as “tip-receiving end 92,” opens to tip receptacle 96, while the other end of cap 90 is substantially closed and is, therefore, referred to herein as “substantially closed end 94.”

Tip-receiving end 92 may be configured to receive tip 30 (i.e., have a shape which is complementary to that of at least a portion of elongate section 32a) and to secure to elongate section 32a of exposed end 32 thereof (FIG. 2). By way of example only, tip-receiving end 92 may be secured to elongate section 32a by way of an interference fit (i.e., friction). Alternatively, an inner surface of tip-receiving end 92 and an outer surface of elongate section 32a may include complementary engaging features, such as threading, corresponding protruding features and recesses therefor, or the like. When tip-receiving end 92 of cap 90 is secured to elongate section 32a, rotation of cap 90 may also cause tip 30 to rotate, thereby facilitating the extrusion of tacky material of grasping element 50 therefrom.

All or part of outer surface 98 may be knurled, include ridges, or be otherwise roughened to facilitate gripping thereof and removal thereof from body 20. Such roughening of outer surface 98 may also facilitate rotation of cap 90 and, thus, of tip 30, to cause grasping element 50 to be extruded therefrom.

Tip receptacle 96 is configured to receive and contain tip 30, protecting the same, as well as tacky material of grasping element 50 therein and protruding therefrom, when grasping element 50 is not being used. Accordingly, substantially closed end 94 of cap 90 prevents dust, lint, and other contaminants from sticking to exterior end 54 of grasping element 50 when cap 90 is placed thereover. Substantially closed end 94 may also prevent manipulation of and, thus, changes to the shape of exterior end 54 of grasping element 50 when cap 90 is positioned thereover.

With returned reference to FIG. 2, body 20 (or, optionally, cap 90) may also include a clip 100, of a type known in the art, secured to an outer surface 21 of body 20. Clip 100 includes a spacing element 102 which extends away from outer surface 21 and which secures clip 100 to body 20. Clip 100 also includes an elongate retention element 104, which extends from spacing element 102 toward end 24 of body 20 and which is oriented substantially parallel to longitudinal axis 31 of body 20. Additionally, clip 100 may include a protruding element 106 that extends from elongate retention element 104 in substantially the same direction as spacing element 102 extends and which is configured to be disposed between elongate retention element 104 and outer surface 21 of body 20. Protruding element 106 may space elongate retention element 104 a suitable distance apart from outer surface 21 that a thin member (e.g., a pocket, sleeve, cover of a notebook, sheet of paper, etc.) may be disposed therebetween, as well as facilitate the retention of such a thin member between elongate retention element 104 and outer surface 21 of body 20.

Also, pick-and-place apparatus 10 may include an accessory tool 60, an example of which is shown in FIG. 7. In the illustrated example and with returned reference to FIGS. 1 and 2, accessory tool 60 and body 20 are configured such that accessory tool 60 may be secured to body 20.

In this regard, section 25b of storage cavity 25 of body 20 may be configured to receive and engage at least a portion of accessory tool 60. For example, accessory attachment element 29 of section 25b and a portion of accessory tool 60 may mutually engage each other by way of an interference fit (i.e., friction) or by complementarily configured means for securing (e.g., complementary threading, complementary indents and protrusions,.etc.) at an inner surface of accessory-attachment element 29 of section 25b and the engaged portion of accessory tool 60.

The illustrated example of accessory tool 60 includes a center section 62 and two tools 64 and 74 protruding from opposite ends 63 and 73, respectively, of center section 62.

Center section 62 may be configured to serve as a region of accessory tool 60 which is to be manually held, or gripped, by a user of accessory tool 60.

Tool 64 may, for example, comprise the depicted placement tip and, thus, is also referred to herein as “placement tip 64.” Also by way of example, tool 74 may comprise a rounded stylus, as shown, and is, therefore, also referred to herein as “rounded stylus 74.” Of course, accessory tools that include other types of tools (e.g., styli, tweezers, scrapers, cutting blades, ball-points, pokers, applicators for adhesives or other materials, brushes, writing or marking instruments, etc.) are also within the scope of the present invention.

Tools 64 and 74 may be formed integrally with center section 62, as shown in FIG. 7. Alternatively, as depicted in FIG. 7A, an accessory tool 60 may include tools 64 and 74 which are configured to be removably secured to ends 63 and 73 thereof. By way of example only, ends 63 and 73 and complementary portions of tools 64 and 74 may be threaded or include interconnecting elements that may be secured to one another and held in place magnetically, adhesively, by an interference fit, or with “snap-on“ type features, such as by introduction of a protruding feature (e.g., a ridge or spring-loaded bearing) into a corresponding recess, or by any other suitable means known in the art.

Tool 64, 74 includes a body-engagement element 68, 78 protruding from and located adjacent to each end 63, 73 of center section 62. Body-engagement element 68, 78 is configured to be inserted into and secured within accessory-attachment element 29 of section 25b of storage cavity 25 of body 20. As shown, at least one dimension OD₆₈, OD₇₈ (e.g., an outer diameter) of a cross-section of body-engagement element 68, 78 taken transverse to a longitudinal axis 61 of accessory tool 60 is about the same as at least one corresponding dimension ID29 (e.g., an inner diameter) (FIG. 2) of a cross-section of accessory-attachment element 29 taken transverse to a longitudinal axis 21 (FIG. 1) of body 20. Of course, if body-engagement element 68, 78 includes additional means for engaging the means for engaging of accessory-attachment element 29 (e.g., threading, corresponding tabs and recesses, etc.), dimension OD₆₈, OD₇₈ may be somewhat smaller than the corresponding dimension ID29 so as to accommodate such means for engaging.

Additionally, if dimension OD₆₈, OD₇₈ is less than a corresponding dimension OD₆₂ (e.g., outer diameter) of center section 62 taken transverse to longitudinal axis 61, a ledge 66, 76 is formed at the corresponding end 63, 73 of center section 62. Each such ledge 66, 76 may prevent accessory tool 60 from being inserted too far into section 25b of storage cavity 25 of body 20.

An elongate element 70, 80 extends from an end of a corresponding body-engagement element 68, 78, opposite from center section 62, to a corresponding tool end 72, 82. To facilitate its storage within section 25b of storage cavity 25 of body 20, each elongate element 70, 80 may have at least one cross-sectional dimension OD₇₀, OD₈₀ (e.g., outer diameter) taken transverse to longitudinal axis 61 which is somewhat less than the corresponding cross-sectional dimension OD₆₈, OD₇₈ of the adjacent body-engagement end 68, 78. Accordingly, each tool 64, 74 may include a taper 69, 79 between body-engagement element 68, 78 and elongate element 70, 80 thereof.

As shown, tool end 72 comprises a substantially conically shaped pointed end which protrudes from elongate element 70, while tool end 82 comprises a rounded end of elongate element 80. Accordingly, tool ends 72 and 82 are also respectively referred to herein as “pointed end 72” and “rounded end 82.”

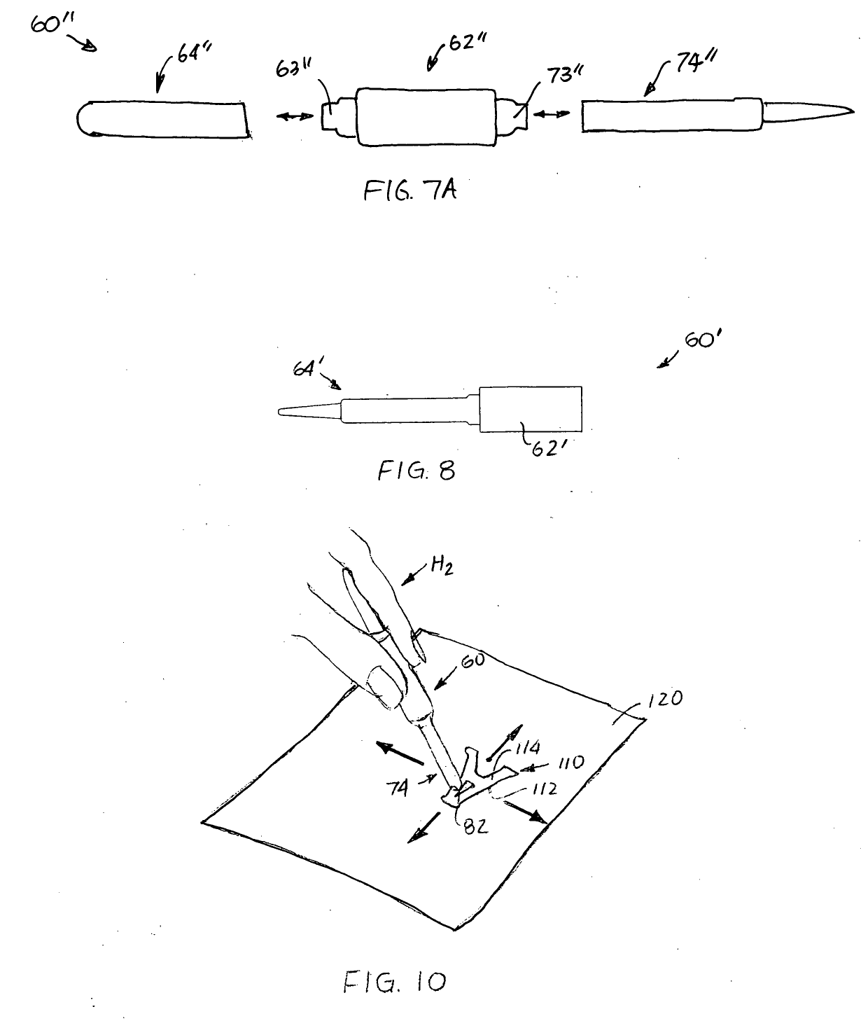

Of course, as shown in FIG. 8, accessory tools 60 that include only a single tool 64 and, thus, include a handling end 62 rather than a center section, are also within the scope of the present invention. Further, accessory tools that are securable in a different manner to a body 20 (FIGS. 1 and 2) of a pick-and-place apparatus 10 that incorporates teachings of the present invention are also within the scope of the present invention.

With returned reference to FIG. 7, accessory tool 60 may, by way of example only, be secured to body 20 of pick-and-place apparatus 10 by substantially aligning longitudinal axis 61 of accessory tool 60 and longitudinal axis 21 of body 20, and inserting tool end 72, 82 through accessory-attachment element 29 and into section 25b of storage cavity 25 of body 20. Body-engagement element 68, 78 and accessory-attachment element 29 may then be caused to engage one another, as appropriate for the type of means for engagement thereof.

Removal of accessory tool 60 from body 20 of pick-and-place apparatus 10 merely requires reversal of the foregoing process.

When use of a tool 64, 74 of accessory tool 60 is desired, accessory tool 60 may be oriented relative to body 20 such that the desired tool 64, 74 protrudes therefrom. Alternatively, accessory tool 60 may be removed from body 20 and used separately therefrom, as shown in FIGS. 9A-10.

FIGS. 9A and 9B depict the use of pointed end 72. In FIG. 9A, a piece 110 of a sheet of material (e.g., paper, plastic film, cloth, foil, etc.), is stuck to an exposed end 54 of grasping element 50 that protrudes from tip 30 of pick-and-place apparatus 10. Body 20 of pick-and-place apparatus 10 may be held with a hand H₁ of an individual. Once piece 110 has been positioned at a desired location on a substrate 120 (e.g., a sheet of a scrapbook, another sheet of paper or card stock, a poster board, etc.), or if removal of piece 110 from exposed end 54 of grasping element 50 is otherwise desired, the individual, with center section 62 of accessory tool 60 grasped by with her other hand H₂, may bring accessory tool 60 in proximity to piece 110 and position pointed end 72 of placement tip 64 in contact with piece 110, thereby holding piece in place upon substrate 120 or another surface.

Next, as shown in FIG. 9B, the individual may pull the remainder (i.e., grasping element 50, tip 30, and body 20) of pick-and-place apparatus 10 from piece 110 with her hand H₁, thereby separating exposed end 54 of grasping element 50 from piece 110 and allowing piece 110 to remain in place.

As depicted in FIG. 10, if an adhesive, such as glue, has already been applied to a bottom surface 112 of piece 110, adhesion of the adhesive-coated surface 112 of piece 110 to a substrate 120 may be effected by changing the position of accessory tool 60 within hand H₂ of the individual, then bringing rounded stylus 74 into proximity to piece 110, with rounded end 82 thereof contacting an upper surface 114 of piece 110. Thereafter, the individual may move rounded end 82 laterally over portions or substantially all of surface 114. In so doing, rounded end 82 applies pressure to upper surface 114, causing adhesive on bottom surface 112 to contact substrate 120 and to spread between bottom surface 112 and substrate 120, thereby facilitating adhesion of piece 110 to substrate 120.

Accessory tool 60 may then be replaced upon body 20.

Of course, use of accessory tool 60 while it is secured to body 20 of pick-and-place apparatus 10 is also within the scope of the present invention.

Although the foregoing description contains many specifics, these should not be construed as limiting the scope of the present invention, but merely as providing illustrations of some of the presently preferred embodiments. Similarly, other embodiments of the invention may be devised which do not depart from the spirit or scope of the present invention. Moreover, features from different embodiments of the invention may be employed in combination. The scope of the invention is, therefore, indicated and limited only by the appended claims and their legal equivalents, rather than by the foregoing description. All additions, deletions, and modifications to the invention, as disclosed herein, which fall within the meaning and scope of the claims are to be embraced thereby.

1. A hand-held pick-and-place apparatus, comprising:
a body configured to be grasped by a hand of an individual;
a grasping element associated with an end of the body and including an end for adhesion to a piece to be picked while leaving substantially no residue on the piece.

2. The hand-held pick-and-place apparatus of claim 1, wherein the body includes a chamber for receiving at least a portion of the grasping element.

3. The hand-held pick-and-place apparatus of claim 1, further comprising:
a tip securable to the body, the tip including at least one channel through at least a portion of a length thereof, the at least one channel being configured to receive at least a portion of the grasping element, the end for adhesion exposable through an end of the tip.

4. The hand-held pick-and-place apparatus of claim 3, wherein the tip is configured to move longitudinally to a plurality of positions relative to the body to facilitate at least one of exposure and storage of the grasping element.

5. The hand-held pick-and-place apparatus of claim 4, wherein a tip-engagement element of the body and a body-engagement element of the tip include complementary threading.

6. The hand-held pick-and-place apparatus of claim 5, further comprising:
a cap configured to receive at least the end for adhesion of the grasping element and to be secured to the tip.

7. The hand-held pick-and-place apparatus of claim 6, wherein the cap is configured to be secured to the tip such that rotation of the cap results in rotation of the tip.

8. The hand-held pick and place apparatus of claim 4, further comprising a plunger including a tip positioned coaxially within the body and configured to be positioned in-line with the at least one channel of the tip for insertion therein.

9. The hand-held pick-and-place apparatus of claim 4, further comprising:
an interior fixed element within the body which limits a distance the tip may be inserted into a chamber of the body.

10. The hand-held pick-and-place apparatus of claim 1, further comprising:
a cap configured to receive at least the end for adhesion of the grasping element and to be secured in place relative to the body.

11. The hand-held pick-and-place apparatus of claim 1, further comprising:
an accessory tool configured to be secured to another end of the body.

12. The hand-held pick-and-place apparatus of claim 11, wherein at least a portion of the accessory tool is configured to be received by the another end of the body.

13. The hand-held pick-and-place apparatus of claim 11, wherein the accessory tool includes a portion which is configured to be grasped by a hand of the individual.

14. The hand-held pick-and-place apparatus of claim 11, wherein the accessory tool includes a tool comprising at least one of a rounded stylus, a placement tip, tweezers, a ball point, an adhesive applicator, a brush, a scraper, a cutting blade, a poker, and a writing or marking instrument.

15. The hand-held pick-and-place apparatus of claim 11, wherein the accessory tool includes at least two tools which extend in opposite directions.

16. The hand-held pick-and-place apparatus of claim 15, wherein at least one of the at least two tools is configured to be at least partially received within a chamber of the body that communicates with the another end.

17. The hand-held pick-and-place apparatus of claim 15, wherein at least one of the at least two tools is configured to be removed from a center section of the accessory tool.

18. An adhesive tip for a hand-held pick-and-place apparatus, comprising:
a tip including:
a body-engagement element configured to be secured to a body of the hand-held
pick-and-place apparatus; and
at least one channel extending longitudinally through at least a portion of the tip; and
a grasping element disposed at least partially within the at least one channel.

19. The adhesive tip of claim 18, wherein at least one end of the grasping element protrudes from the body-engagement element.

20. A method for moving a piece, comprising:
contacting the piece with an exposed exterior end of a grasping element associated with a hand-held pick-and-place apparatus so as to caused the exposed exterior end to adhere to the piece; and
moving the hand-held pick-and-place apparatus while the piece remains adhered to the exposed exterior end.

21. The method of claim 20, further comprising:
providing at least a portion of a grasping element at an end of the hand-held pick-and-place apparatus.

22. The method of claim 21, wherein providing comprises extruding a portion of the grasping element from a tip of the hand-held pick-and-place apparatus to expose an exterior end of the grasping element.

23. The method of claim 22, wherein extruding comprises rotating the tip of the hand-held pick-and-place apparatus relative to a body thereof.

24. The method of claim 23, wherein rotating comprises rotating a cap secured to the tip.

25. The method of claim 21, further comprising: forming at least the portion of the grasping element to a desired shape.

26. The method of claim 20, further comprising:
holding the hand-held pick-and-place apparatus at an orientation that provides access to a surface of the piece.

27. The method of claim 26, further comprising:
applying material to the surface of the piece while the piece is adhered to the exposed exterior end.

28. The method of claim 26, further comprising:
manipulating or modifying the piece while the piece is adhered to the exposed exterior end.

29. The method of claim 20, further comprising:
moving the piece to a desired location of a substrate; and
placing the piece at the desired location.

30. The method of claim 29, further comprising:
separating an accessory tool from the hand-held pick-and-place apparatus;
positioning a placement tip of the accessory tool against the piece; and
pulling the hand-held pick-and-place apparatus away from the piece while the placement tip is positioned against the piece.

31. The method of claim 30, further comprising:
placing a rounded stylus against the piece; and
moving the rounded stylus laterally across at least a portion of a surface of the piece to secure the piece to the substrate.

32. The method of claim 31, wherein placing is effected by repositioning the accessory tool.

33. A method for using a hand-held pick-and-place apparatus, comprising:
grasping the hand-held pick-and-place apparatus; and
ensuring that an end of a grasping element of the hand-held pick-and-place apparatus is exposed from an end thereof.

34. The method of claim 33, wherein ensuring comprises extruding the end of the grasping element from the end of the hand-held pick-and-place apparatus.

35. The method of claim 34, wherein extruding comprises moving a tip of the hand-held pick-and-place apparatus longitudinally into a body thereof, the grasping element remaining in a substantially stationary position relative to the body.

36. The method of claim 34, wherein extruding comprises moving a position of the grasping element within the hand-held pick-and-place apparatus toward the end thereof.

37. The method of claim 33, wherein ensuring comprises supplying the hand-held pick-and-place apparatus with a replacement grasping element.

38. The method of claim 37, wherein supplying comprises:
removing a tip of the hand-held pick-and-place apparatus from a body thereof.

39. The method of claim 38, wherein supplying further comprises:
placing the replacement grasping element at least partially within the tip; and
resecuring the tip to the body.

40. The method of claim 38, wherein supplying further comprises:
securing a replacement tip including the replacement grasping element to the body.
